(19) United States
(12) Patent Application Publication
(10) Pub. No.: US 2025/0296058 A1
(43) Pub. Date: Sep. 25, 2025

(54) CENTRIFUGAL DISPERSION DEVICE

(71) Applicant: SHANGSHUI SMARTECH LTD., Shenzhen (CN)

(72) Inventors: Baodong DU, Shenzhen (CN); Jian KE, Shenzhen (CN); Xudong JIN, Shenzhen (CN); Qiao SHI, Shenzhen (CN)

(21) Appl. No.: 19/230,641

(22) Filed: Jun. 6, 2025

Related U.S. Application Data
(63) Continuation of application No. PCT/CN2023/087828, filed on Apr. 12, 2023.

(30) Foreign Application Priority Data
Dec. 7, 2022 (CN) 202211570043.4

(51) Int. Cl. B01F 27/271

(52) U.S. Cl. CPC B01F 27/271; B01F 2215/0431

(57) ABSTRACT

A centrifugal dispersion device is provided. The centrifugal dispersion device includes a cylinder body, multiple rotor units, and multiple stator units. The cylinder body is internally provided with a shaft core. Each rotor unit includes a rotor inner cylinder, a rotor outer cylinder, and a rotor rib-plate. The rotor inner cylinder is fixedly sleeved on the shaft core and rotatable along with the shaft core. The rotor inner cylinder and the rotor outer cylinder cooperatively define a rotor cavity. Each stator unit includes a stator cylinder and a blocking portion. The stator cylinder is fixedly connected to an inner wall of the cylinder body. The blocking portion extends from an inner wall of the stator cylinder into a gap between adjacent two of the multiple rotor units. A first flow-passing channel is defined between the inner wall of the stator cylinder and an outer wall of the rotor outer cylinder.

### CROSS-REFERENCE TO RELATED APPLICATION(S)

The application is a continuation of International Application No. PCT/CN2023/087828, filed Apr. 12, 2023, which claims priority to Chinese Patent Application No. 202211570043.4, filed Dec. 7, 2022, the entire disclosure of which are hereby incorporated by reference.

### TECHNICAL FIELD

This disclosure relates to the field of slurry-dispersing-apparatus technology, and in particular to a centrifugal dispersion device.

### BACKGROUND

For existing twin-screw extrusion devices, all functional elements are strung on two parallel screws, to contain all functions such as powder transportation, powder mixing, kneading, dilution, and dispersion. However, since the demand for rotational speed of the dispersion function is not consistent with the demand for rotational speed of other functions as mentioned earlier, and the difference is great, a dispersion effect cannot meet the needs of use.

### SUMMARY

A centrifugal dispersion device is provided in the disclosure. The centrifugal dispersion device includes a cylinder body, multiple rotor units, and multiple stator units. The cylinder body is configured to be in communication with a discharge end of a screw extrusion device, and internally provided with a shaft core that is rotatable under driving of a driving member. Each of the multiple rotor units includes a rotor inner cylinder, a rotor outer cylinder, and a rotor rib-plate connected between the rotor inner cylinder and the rotor outer cylinder. The rotor inner cylinder is fixedly sleeved on the shaft core and rotatable along with the shaft core. The rotor inner cylinder and the rotor outer cylinder cooperatively define a rotor cavity at at least one side of the rotor rib-plate. A cylinder wall of the rotor outer cylinder defines multiple flow-passing holes in communication with the rotor cavity. The multiple stator units are alternately arranged with the multiple rotor units in an axial direction of the shaft core. Each of the multiple stator units includes a stator cylinder and a blocking portion. The stator cylinder is fixedly connected to an inner wall of the cylinder body. The blocking portion extends from an inner wall of the stator cylinder into a gap between adjacent two of the multiple rotor units. A first flow-passing channel configured for shearing of a slurry is defined between the inner wall of the stator cylinder and an outer wall of the rotor outer cylinder. The first flow-passing channel is in communication with the multiple flow-passing holes.

### BRIEF DESCRIPTION OF THE DRAWINGS

In order to explain technical solutions in implementations of the disclosure or the related art more clearly, the following will give a brief introduction to the accompanying drawings required for describing implementations or the related art. Apparently, the accompanying drawings in the following description illustrate some implementations of the disclosure. For those of ordinary skill in the art, other accompanying drawings can be obtained according to these accompanying drawings without creative efforts.

FIG. 1 is an exploded view of a centrifugal dispersion device provided in some embodiments of the disclosure.

FIG. 2 is a half cross-sectional view of a centrifugal dispersion device provided in some embodiments of the disclosure.

FIG. 3 is a structural view of region A shown in FIG. 2.

FIG. 4 is a schematic structural view of a rotor unit of a centrifugal dispersion device provided in some embodiments of the disclosure.

Description of reference signs of the accompanying drawings:

1—cylinder body, 2—rotor unit, 3—stator unit, 4—shaft core, 5—driving member, 6—rotor cavity, 7—first flow-passing channel, 8—second flow-passing channel, 9—third flow-passing channel, 11—front end-plate, 12—rear end-plate, 21—rotor inner cylinder, 22—rotor outer cylinder, 23—rotor rib-plate, 221—flow-passing hole, 30—stator cylinder, 31—blocking portion, 51—spindle.

### DETAILED DESCRIPTION

The following will clearly and completely describe technical solutions of the disclosure with reference to the accompanying drawings. Apparently, embodiments described herein are merely some embodiments of the disclosure, rather than all embodiments of the disclosure. Based on the embodiments of the disclosure, all other embodiments obtained by those of ordinary skill in the art without creative effort shall fall within the protection scope of the disclosure.

In the description of the disclosure, it should be noted that the orientation or positional relations indicated by terms such as “center”, “upper”, “lower”, “left”, “right”, “vertical”, “horizontal”, “inner”, “outer”, etc., are orientation or positional relationships based on the accompanying drawings, are only for facilitating the description of the disclosure and simplifying the description, rather than indicating or implying that the referred device or element must be in a particular orientation or constructed or operated in a particular orientation, and therefore cannot be construed as limiting the disclosure. Furthermore, the terms “first”, “second”, and “third” are used for descriptive purposes only and cannot be construed as indicating or implying relative importance.

In the description of the disclosure, it should be noted that, unless specified or limited otherwise, the terms “mounting”, “coupling”, “connecting” should be understood in a broad sense. For example, coupling may be a fixed coupling, or a detachable coupling, or an integrated coupling, may be a mechanical coupling, an electrical coupling, and may be a direct coupling, an indirect coupling through a medium, or a communication coupling between two elements. For those of ordinary skill in the art, the specific meaning of the above terms in the disclosure can be understood in specific cases.

In addition, the technical features involved in the different implementations of the disclosure described below can be combined with each other as long as they do not constitute a conflict with each other.

Currently on the market, the solution to the insufficient dispersion capacity of the twin screw is to add a buffer tank at the rear end of the twin-screw, and use the high and low speed mixing shaft of the buffer tank to disperse the slurry. However, this solution to the problem sacrifices the natural advantages of continuous production of the twin-screw extrusion device. The twin-screw itself is for continuous production, which liberates production capacity. However, the rear buffer tank can only be stirred batch by batch to output to the rear-end process, so that continuous slurry preparation operation cannot be realized and production capacity is reduced.

The technical problem to be solved by the disclosure is to overcome the defects of the prior art that continuous slurry preparation operation cannot be realized, the slurry preparation capacity is small, and the efficiency is low, so a centrifugal dispersion device is provided.

To solve the above technical problem, the technical solution of the disclosure is as follows.

A centrifugal dispersion device is provided in the disclosure. The centrifugal dispersion device includes a cylinder body, multiple rotor units, and multiple stator units. The cylinder body is configured to be in communication with a discharge end of a screw extrusion device, and internally provided with a shaft core that is rotatable under driving of a driving member. Each of the multiple rotor units includes a rotor inner cylinder, a rotor outer cylinder, and a rotor rib-plate connected between the rotor inner cylinder and the rotor outer cylinder. The rotor inner cylinder is fixedly sleeved on the shaft core and rotatable along with the shaft core. The rotor inner cylinder and the rotor outer cylinder cooperatively define a rotor cavity at at least one side of the rotor rib-plate. A cylinder wall of the rotor outer cylinder defines multiple flow-passing holes in communication with the rotor cavity. The multiple stator units are alternately arranged with the multiple rotor units in an axial direction of the shaft core. Each of the multiple stator units includes a stator cylinder and a blocking portion. The stator cylinder is fixedly connected to an inner wall of the cylinder body. The blocking portion extends from an inner wall of the stator cylinder into a gap between adjacent two of the multiple rotor units. A first flow-passing channel configured for shearing of a slurry is defined between the inner wall of the stator cylinder and an outer wall of the rotor outer cylinder. The first flow-passing channel is in communication with the multiple flow-passing holes.

According to some embodiments of the disclosure, a second flow-passing channel configured for shearing of the slurry is defined between each of two opposite sidewalls of the blocking portion and a sidewall of the rotor outer cylinder facing the sidewalls of the blocking portion. A third flow-passing channel configured for shearing of the slurry is defined between an inner wall of the blocking portion facing the shaft core and an outer wall of the rotor inner cylinder. The first flow-passing channel, the second flow-passing channel and the third flow-passing channel are communicated in sequence. The third flow-passing channel is in communication with the two second flow-passing channels at both sides of the blocking portion.

According to some embodiments of the disclosure, in a radial direction of the shaft core, a distance between an inner wall of the blocking portion and an inner wall of the stator cylinder is larger than a distance between an inner wall of the rotor outer cylinder and the inner wall of the stator cylinder.

According to some embodiments of the disclosure, an extension direction of the first flow-passing channel and an extension direction of the third flow-passing channel are parallel to the axial direction of the shaft core. An extension direction of the second flow-passing channel is perpendicular to the axial direction of the shaft core.

According to some embodiments of the disclosure, the first flow-passing channel has a width ranging from 2 mm to 3 mm.

According to some embodiments of the disclosure, the rotor cavity is a cavity structure with the rotor rib-plate as a cavity-bottom-wall, the outer wall of the rotor inner cylinder as a cavity-inner-peripheral-wall, an inner wall of the rotor outer cylinder as a cavity-outer-peripheral-wall, and one end of the rotor cavity facing away from the rotor rib-plate as an opening. The rotor cavity is in direct communication with both the second flow-passing channel and the third flow-passing channel.

According to some embodiments of the disclosure, the rotor rib-plate is integrally formed at a middle of each of the rotor inner cylinder and the rotor outer cylinder. The rotor cavity is defined at each of two opposite sides of the rotor rib-plate, and the rotor outer cylinder corresponding to each of two rotor cavities defines the flow-passing holes.

According to some embodiments of the disclosure, there are multiple flow-passing holes. The multiple flow-passing holes are arranged at regular intervals in a circumferential direction of the rotor outer cylinder.

According to some embodiments of the disclosure, the cylinder body is provided with a front end-plate at one end of the cylinder body away from the driving member in the axial direction of the shaft core. The front end-plate is adapted to be connected to the screw extrusion device. The front end-plate is configured to be sealed with and connected to an outer cylinder of the screw extrusion device through a fastener.

According to some embodiments of the disclosure, the cylinder body is provided with a rear end-plate at one end of the cylinder body close to the driving member in the axial direction of the shaft core. The driving member is sealed with and connected to the rear end-plate. The driving member is a motor. The motor is provided with a spindle that extends into the interior of the cylinder body and is connected to an output end of the motor. The shaft core is connected to the spindle at an outer periphery of the spindle. The cylinder body is sealed with and connected to the spindle.

According to some embodiments of the disclosure, each of the multiple rotor units has a dispersion speed ranging from 10 m/s to 30 m/s.

The technical solution of the disclosure, has the following advantages:

1. For the centrifugal dispersion device provided in the disclosure, the multiple stator units and the multiple rotor units are alternately mounted in the cylinder body. The rotor inner cylinder is fixedly sleeved on the shaft core and rotatable along with the shaft core. The rotor inner cylinder and the rotor outer cylinder cooperatively define the rotor cavity at the at least one side of the rotor rib-plate. A cylinder wall of the rotor outer cylinder defines multiple flow-passing holes in communication with the rotor cavity. The first flow-passing channel is defined between the inner wall of the stator cylinder and the outer wall of the rotor outer cylinder, and the first flow-passing channel is in communication with the multiple flow-passing holes. When the slurry is extruded from the screw extrusion device and flows into the cylinder body, and flows into the rotor cavity, as the rotor unit is rotated with the shaft core, under the action of the centrifugal force, the slurry abuts against and is pressed against the inner wall of the rotor outer cylinder. That is, the slurry flows through the flow-passing hole, and under the flow of the slurry, a local pressure change occurs in the slurry-filled flow-passing hole, and the local pressure change will be dispersed around the flow-passing hole, thus driving the slurry to irregularly move, so as to achieve the initial overall dispersion of the slurry. In addition, the slurry forms turbulent flow in the flow-passing hole, so that the slurry can be further dispersed. The slurry is dispersed through the flow-passing holes on the rotor outer cylinder and then flows to the first flow-passing channel. During the rotation of the rotor unit, the relative motion of the rotor unit and the stator unit causes a relatively large shear force in the first flow-passing channel, to carry out secondary shear dispersion on the slurry in the first flow-passing channel. The slurry flows backward along the axial direction from the first flow-passing channel. The centrifugal dispersion device has a relatively strong dispersion ability, and can realize quick dispersion of the slurry and improve the dispersion efficiency of the slurry.

2. For the centrifugal dispersion device provided in the disclosure, the second flow-passing channel is defined between each of two opposite sidewalls of the blocking portion and the sidewall of the rotor outer cylinder facing the sidewalls of the blocking portion, and the third flow-passing channel is defined between the inner wall of the blocking portion facing the shaft core and the outer wall of the rotor inner cylinder. The first flow-passing channel, the second flow-passing channel and the third flow-passing channel are communicated in sequence, and the third flow-passing channel is in communication with the two second flow-passing channels at both sides of the blocking portion. Under the action of the blocking portion, the slurry flows through the second flow-passing channel and the third flow-passing channel in sequence, and enters the next rotor unit to be centrifugally dispersed.

3. For the centrifugal dispersion device provided in the disclosure, the blocking portion disposed between the two rotor units blocks the slurry in the rotor cavity, to prevent the slurry from flowing out of the opening of the rotor cavity during the rotation of the rotor unit, so that the slurry abuts against the rotor outer cylinder. In addition, due to the blocking portion, the flow of the slurry forms turbulent flow, so that part of the slurry flows back to the first flow-passing channel to be sheared and dispersed again, thus improving the dispersion degree of the slurry. The blocking portion effectively improves the dispersion ability of the centrifugal dispersion device, so that the slurry can be fully dispersed.

4. For the centrifugal dispersion device provided in the disclosure, the rotor outer cylinder defines the rotor cavity at each of the two opposite sides of the rotor rib-plate. The wall of the rotor outer cylinder corresponding to each of two rotor cavities defines flow-passing holes. After the slurry is centrifugally dispersed in the front-end rotor cavity, the slurry flows into the first flow-passing channel to be sheared and dispersed again, and flows backward along the axial direction in the first flow-passing channel. After the slurry is blocked by the blocking portion, the turbulent flow is formed, so that part of the slurry flows back to the first flow-passing channel, and another part of the slurry flows along the second flow-passing channel. The opening of the rear-side rotor cavity is in communication with the second flow-passing channel, so that the another part of the slurry that flows into the rear-side rotor cavity is centrifugally dispersed again, and re-enters into the first flow-passing channel. The rotor cavity is defined at each of the two opposite sides of the rotor rib-plate, so that the slurry can be centrifugally dispersed in a reciprocating manner, the slurry can be fully dispersed, and the efficiency of centrifugal dispersion is effectively improved.

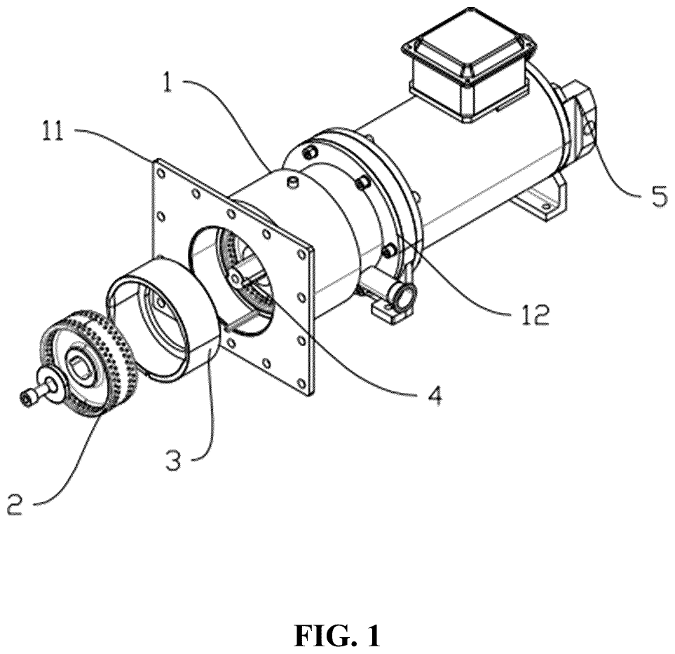

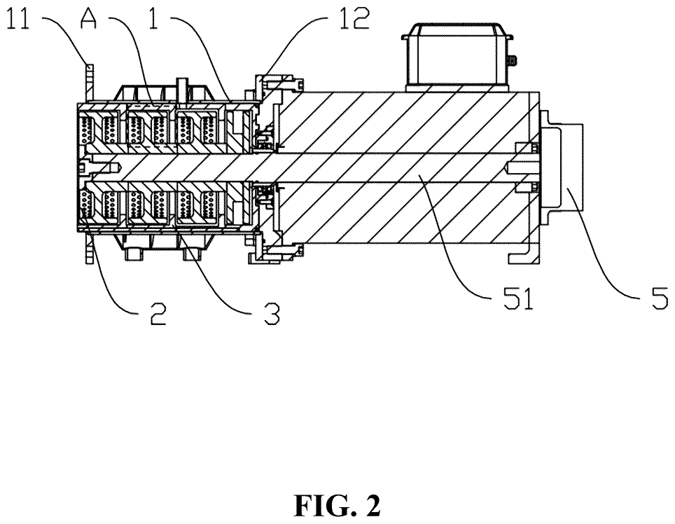

Reference can be made to FIG. 1 to FIG. 4, and a centrifugal dispersion device provided in the disclosure includes a cylinder body 1, multiple rotor units 2, and multiple stator units 3. The cylinder body 1 is configured to be in communication with a discharge end of a screw extrusion device, and internally provided with a shaft core 4 that is rotatable under driving of a driving member 5. Each of the multiple rotor unit 2 includes a rotor inner cylinder 21 and a rotor outer cylinder 22, and a rotor rib-plate 23 connected between the rotor inner cylinder 21 and the rotor outer cylinder 22. The rotor inner cylinder 21 is fixedly sleeved on the shaft core 4 and rotatable along with the shaft core 4. The rotor inner cylinder 21 and the rotor outer cylinder 22 cooperatively define a rotor cavity 6 at at least one side of the rotor rib-plate 23. A cylinder wall of the rotor outer cylinder 22 defines multiple flow-passing holes 221 in communication with the rotor cavity 6.

The multiple stator units 3 are alternately arranged with the multiple rotor units 2 in an axial direction of the shaft core 4. Each of the multiple stator units 3 includes a stator cylinder 30 and a blocking portion 31. The stator cylinder 30 is fixedly connected to an inner wall of the cylinder body 1. The blocking portion 31 extends from an inner wall of the stator cylinder 30 into a gap between adjacent two of the multiple rotor units 2.

A first flow-passing channel 7 is defined between the inner wall of the stator cylinder 30 and the outer wall of the rotor outer cylinder 22, and the first flow-passing channel 7 is in communication with the multiple flow-passing holes 221. A second flow-passing channel 8 is defined between each of two opposite sidewalls of the blocking portion 31 and a sidewall of the rotor outer cylinder 22 facing the sidewalls of the blocking portion 31. A third flow-passing channel 9 is defined between an inner wall of the blocking portion 31 facing inner wall of the shaft core 4 and an outer wall of the rotor inner cylinder 21. The first flow-passing channel 7, the second flow-passing channel 8, and the third flow-passing channel 9 are communicated in sequence. The third flow-passing channel 9 is in communication with two second flow-passing channels 8 at both sides of the blocking portion 31.

Specifically described, the multiple stator units 3 are alternately arranged with the multiple rotor units 2 in the axial direction of the shaft core 4. The rotor inner cylinder 21 is fixedly sleeved on the shaft core 4 and rotatable along with the shaft core 4. The rotor inner cylinder 21 and the rotor outer cylinder 22 cooperatively define the rotor cavity 6 at the at least one side of the rotor rib-plate 23. The cylinder wall of the rotor outer cylinder 22 defines the multiple flow-passing holes 221 in communication with the rotor cavity 6. The first flow-passing channel 7 configured for shearing of the slurry is defined between the inner wall of the stator cylinder 30 and the outer wall of the rotor outer cylinder 22. The first flow-passing channel 7 is in communication with the multiple flow-passing holes 221.

The second flow-passing channel 8 configured for shearing of the slurry is defined between each of the two opposite sidewalls of the blocking portion 31 and the sidewall of the rotor outer cylinder 22 facing the sidewall of the blocking portion 31. The third flow-passing channel 9 configured for shearing of the slurry is defined between the inner wall of the blocking portion 31 facing the shaft core 4 and the outer wall of the rotor inner cylinder 21. The first flow-passing channel 7, the second flow-passing channel 8, and the third flow-passing channel 9 are communicated in sequence. The third flow-passing channel 9 is in communication with the two second flow-passing channels 8 at both sides of the blocking portion 31.

It can be understood that, when the slurry is extruded from the screw extrusion device and flows into the cylinder body 1, and flows into the rotor cavity 6, as the rotor unit 2 is rotated with the shaft core 4, under the action of the centrifugal force, the slurry abuts against and is pressed against the inner wall of the rotor outer cylinder 22. That is, the slurry flows through the flow-passing hole 221, and under the flow of the slurry, a local pressure change occurs in the slurry-filled flow-passing hole 221, and the local pressure change will be dispersed around the flow-passing hole 221, thus driving the slurry to irregularly move, so as to achieve the initial overall dispersion of the slurry. In addition, the slurry forms turbulent flow in the flow-passing hole 221, so that the slurry can be further dispersed. The slurry is dispersed through the flow-passing holes 221 on the rotor outer cylinder 22 and then flows to the first flow-passing channel 7. After the slurry flows into the first flow-passing channel 7, the slurry flowing out of the flow-passing hole 221 is blocked by the stator cylinder 30, so that part of the slurry flows back. The slurry will flow through the flow-passing hole 221 in a reciprocating manner, and a dense convection is formed at the multiple flow-passing holes 221, to complete the initial dispersion of the slurry quickly.

During the rotation of the rotor unit 2, the relative motion of the rotor unit 2 and the stator unit 3 causes a relatively large shear force in the first flow-passing channel 7, to carry out secondary shear dispersion on the slurry in the first flow-passing channel 7. The slurry flows backward along the axial direction from the first flow-passing channel 7. Under the action of the blocking portion 31, the slurry flows through the second flow-passing channel 8 and the third flow-passing channel 9 in sequence, and enters the next rotor unit 2 to be centrifugally dispersed. The centrifugal dispersion device has a relatively strong dispersion ability, and can realize quick dispersion of the slurry and improve the dispersion efficiency of the slurry.

It should be noted that, the multiple flow-passing holes 221 communicating with the rotor cavity 6 are defined on the cylinder wall of the rotor outer cylinder 22. The number, shape, and size of the flow-passing holes 221 are not a limitation of the disclosure. The smaller the size of the flow-passing hole 221, the stronger the centrifugal dispersion ability, but the slower the dispersion efficiency. The flow-passing holes 221 can be arranged at regular intervals in the circumferential direction of the cylinder wall of the rotor outer cylinder 22, or irregular intervals.

The stator units 3 and the rotor units 2 are alternately arranged. The specific number of the stator unit 3 and the rotor unit 2 can be determined according to the slurry to be fed in the actual application. The increase in the number of groups of the stator unit 3 and the rotor unit 2 can improve the dispersion ability. In some embodiments of the disclosure, the structure of three stator units matched with three rotor units is adopted. The specific number of rotor unit 2 and stator unit 3 is not a limitation of the disclosure.

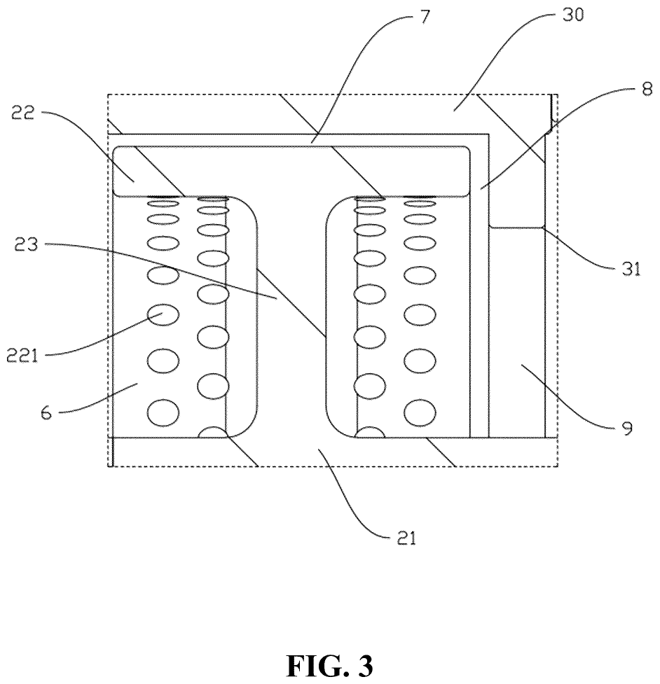

Reference can be made to FIG. 3. In some embodiments of the disclosure, in a radial direction of the shaft core 4, a distance between an inner wall of the blocking portion 31 and the inner wall of the stator cylinder 30 is larger than a distance between an inner wall of the rotor outer cylinder 22 and the inner wall of the stator cylinder 30.

Specifically described, the slurry will preferentially abut against the inner wall of the rotor outer cylinder 22 due to the centrifugal force, so before the slurry flows through the third flow-passing channel 9 into the next rotor unit 2, the slurry will automatically fill up the region outside the inner wall of the blocking portion 31, that is, the slurry will completely submerge all the flow-passing holes 221 on the rotor unit 2, to realize the full centrifugal dispersion of the slurry. The blocking portion 31 disposed between the two rotor units 2 blocks the slurry in the rotor cavity 6, to prevent the slurry from flowing out of the opening of the rotor cavity 6 during the rotation of the rotor unit, so that the slurry abuts against the rotor outer cylinder 22. In addition, due to the blocking portion 31, the flow of the slurry forms turbulent flow, so that part of the slurry flows back to the first flow-passing channel 7 to be sheared and dispersed again, thus improving the dispersion degree of the slurry. The blocking portion 31 effectively improves the dispersion ability of the centrifugal dispersion device, so that the slurry can be fully dispersed.

In some embodiments of the disclosure, a flow direction (i.e., an extension direction) of the first flow-passing channel 7 and a flow direction of the third flow-passing channel 9 are parallel to the axial direction of the shaft core 4. A flow direction of the second flow-passing channel 8 is perpendicular to the axial direction of the shaft core 4.

In some embodiments of the disclosure, the first flow-passing channel 7 has a width ranging from 2 mm to 3 mm.

Specifically described, the width of the first flow-passing channel 7 is a distance between the outer wall of the rotor outer cylinder 22 and the inner wall of the stator cylinder 30. When the distance is smaller, that is, when the width of the first flow-passing channel 7 is narrower, the shear force in the first flow-passing channel 7 is larger, and the rotational speed of the rotor unit 2 is slower. The shear force is larger, the dispersion degree of the slurry is higher, while the rotational speed of the rotor unit 2 is slower, the dispersion efficiency of the slurry is slower. In some embodiments of the disclosure, the width of the first flow-passing channel 7 is set in the range of 2 mm to 3 mm, and the rotor unit 2 has a dispersion speed ranging from 10 m/s to 30 m/s.

It should be noted that, the dispersion speed of the rotor unit 2 is adjustable. In the actual application, the rotational speed of the rotor unit 2 can be adjusted according to the properties of the slurry ingredients, viscosity, etc., to match the requirements of different slurries on the shear dispersion efficiency. The rotational speed of the rotor unit 2 can be adjusted by means of changing the rotational speed of the driving member 5 by a Programmable Logic Controller (PLC). The rotational speed adjustment method for the rotor unit 2 is not a limitation of the disclosure.

The specification and size of the rotor unit 2 and the stator unit 3 can be changed according to the property of the slurry that is fed, to realize the change in the width of the first flow-passing channel 7.

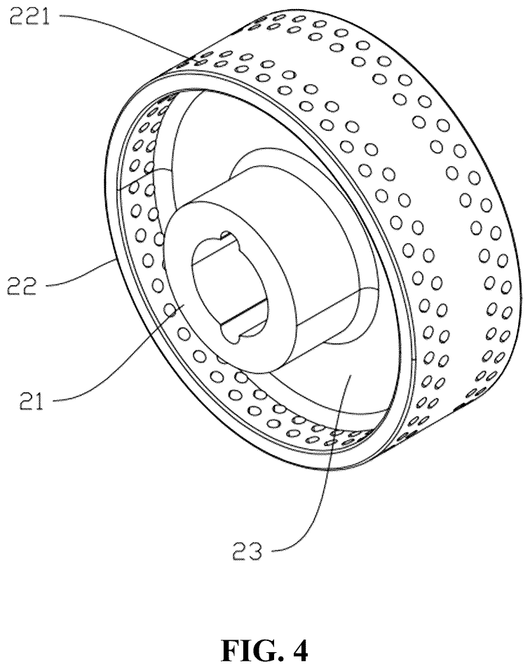

Reference can be made to FIG. 4. In some embodiments of the disclosure, the rotor cavity 6 is a cavity structure with the rotor rib-plate 23 as a cavity-bottom-wall, the outer wall of the rotor inner cylinder 21 as a cavity-inner-peripheral-wall, an inner wall of the rotor outer cylinder 22 as a cavity-outer-peripheral-wall, and one end of the rotor cavity 6 facing away from the rotor rib-plate 23 as an opening. The rotor cavity 6 is in direct communication with both the second flow-passing channel 8 and the third flow-passing channel 9.

In some embodiments of the disclosure, the rotor rib-plate 23 is integrally formed at a middle of each of the rotor inner cylinder 21 and the rotor outer cylinder 22. The rotor cavity 6 is defined at each of two opposite sides of the rotor rib-plate 23, and the rotor outer cylinder 22 corresponding to each of two rotor cavities 6 defines flow-passing holes 221.

Specifically described, the rotor outer cylinder 22 defines the rotor cavity 6 at each of two opposite sides of the rotor rib-plate 23. The wall of the rotor outer cylinder 22 corresponding to each of two rotor cavities 6 defines flow-passing holes 221. After the slurry is centrifugally dispersed in the rotor cavity 6 at the front-end of the rotor rib-plate 23, the slurry flows into the first flow-passing channel 7 to be sheared and dispersed again, and the slurry flows backward along the axial direction in the flow-passing channel 7. After the slurry is blocked by the blocking portion 31, the turbulent flow is be formed, so that part of the slurry flows back to the first flow-passing channel 7, and another part of the slurry flows along the second flow-passing channel 8. The opening of the rotor cavity 6 at the rear-end of the rotor rib-plate 23 is in communication with the second flow-passing channel 8, so that another part of the slurry that flows into the rear-side rotor cavity 6 is centrifugally dispersed again, and re-enters into the first flow-passing channel 7. The rotor cavity 6 is defined at each of two opposite sides of the rotor rib-plate 23, so that the slurry can be centrifugally dispersed in a reciprocating manner, the slurry can be fully dispersed, and the efficiency of centrifugal dispersion is effectively improved.

It can be understood that, the rotor cavity 6 is a smooth cavity without dead corners, thereby avoiding the slurry accumulation in dead zone, and avoiding affecting the dispersion and flow of the slurry.

In some embodiments of the disclosure, there are multiple flow-passing holes 221. The multiple flow-passing holes 221 are arranged at regular intervals in a circumferential direction of the rotor outer cylinder 22.

Specifically described, the multiple flow-passing holes 221 are arranged at regular intervals in the circumferential direction of the rotor outer cylinder 22, so that when the rotor unit 2 rotates, the slurry is dispersed out of the rotor cavity 6, and the dense convection is formed at the multiple flow-passing holes 221, to complete the dispersion of the slurry quickly. The shape of the flow-passing hole 221 may be round or oval or square. The specific shape of the flow-passing hole 221 is not a limitation of the disclosure.

According to some embodiments of the disclosure, the cylinder body 1 is provided with a front end-plate 11 at a port of the cylinder body 1, that is, at one end of the cylinder body 1 away from the driving member 5 in the axial direction of the shaft core 4, and the front end-plate 11 is adapted to be connected to the screw extrusion device. The front end-plate 11 is configured to be sealed with and connected to an outer cylinder of the screw extrusion device through a fastener.

Specifically described, the cylinder body 1 is configured to be sealed with and connected to the end plate at the discharge end of the screw extrusion device. Specifically, the front end-plate 11 is fixedly provided at one end of the cylinder body 1. The front end-plate 11 of the cylinder body 1 and the discharge end of the screw extrusion device are fixedly connected through multiple connecting bolts. Sealing members are provided at the connection surface between the front end-plate 11 of the cylinder body 1 and the discharge end of the screw extrusion device. Thanks to such arrangement, not only can a good seal at the connection between the cylinder body 1 and the screw extrusion device are connected be ensured, to prevent leakage of the slurry, but also the structure is simple and the installation is convenient, which is beneficial for shortening the distance between the end of the screw extrusion device and the rotor unit 2, avoiding the local sedimentation of the slurry due to the excessively long distance, and thus avoiding affecting the quality of the slurry product.

According to some embodiments of the disclosure, the cylinder body 1 is provided with a rear end-plate 12 at one side of the cylinder body 1 close to a slurry outlet, that is, at one end of the cylinder body 1 close to the driving member 5 in the axial direction of the shaft core 4. The driving member 5 is sealed with and connected to the rear end-plate 12. The driving member 5 is a motor. The motor is provided with a spindle 51 that extends into the cylinder body 1 and is connected to an output end of the motor. The shaft core 4 is connected to the spindle 51 at the outer periphery of the spindle 51. The cylinder body 1 is sealed with and connected to the spindle 51.

Specifically described, the driving member 5 is the motor. The output end of the motor is connected to the spindle 51 extending into the cylinder body 1. The shaft core 4 is fixedly connected to the spindle 51 at the outer periphery of the spindle 51. As the rotation of the spindle 51, the cylinder body 1 and the spindle 51 are connected in a sealed manner. Specifically, a sealing structure is provided at the connection between the rear end-plate 12 of the cylinder body 1 and the spindle 51, and the sealing structure can prevent the slurry from leaking outward from the gap at the connection between the cylinder body 1 and the spindle 51.

It can be understood that, the cylinder wall of the cylinder body 1 defines a medium heat-exchange channel. The medium heat-exchange channel has a medium inlet and a medium outlet. The medium heat-exchange channel is helically defined around the wall of the cylinder body 1. Specifically, the medium heat-exchange channel is a cooling-medium channel. The cooling medium enters the cooling-medium channel through the medium inlet, and flows out of the cooling-medium channel through the medium outlet after passing through the cooling-medium channel. The cooling medium can take away part of the heat of the cylinder body 1, to cool down the slurry in the cylinder body 1. Alternatively, the medium heat-exchange channel is a heating-medium channel. The heating medium enters the heating-medium channel through the medium inlet, and flows out of the medium outlet after passing through the heating-medium channel. The heating medium can heat the slurry in the cylinder body 1.

Obviously, the above embodiments are merely examples for the purpose of clear description, and are not a limitation of the implementation. For those of ordinary skill in the art, other different forms of changes or variations can be made on the basis of the above description. It is neither necessary nor possible to exhaust all of the implementation herein. The obvious variations or changes derived therefrom remain within the scope of protection of this description.

What is claimed is:

1. A centrifugal dispersion device, comprising:
a cylinder body configured to be in communication with a discharge end of a screw extrusion device, and internally provided with a shaft core that is rotatable under driving of a driving member;
a plurality of rotor units, wherein each of the plurality of rotor units comprises a rotor inner cylinder, a rotor outer cylinder, and a rotor rib-plate connected between the rotor inner cylinder and the rotor outer cylinder, the rotor inner cylinder is fixedly sleeved on the shaft core and is rotatable along with the shaft core, the rotor inner cylinder and the rotor outer cylinder cooperatively define a rotor cavity at at least one side of the rotor rib-plate, and a cylinder wall of the rotor outer cylinder defines a plurality of flow-passing hole in communication with the rotor cavity; and
a plurality of stator units, alternately arranged with the plurality of rotor units in an axial direction of the shaft core, wherein each of the plurality of stator units comprises a stator cylinder and a blocking portion, the stator cylinder is fixedly connected to an inner wall of the cylinder body, and the blocking portion extends from an inner wall of the stator cylinder into a gap between adjacent two of the plurality of rotor units; wherein
a first flow-passing channel configured for shearing of a slurry is defined between the inner wall of the stator cylinder and an outer wall of the rotor outer cylinder, and the first flow-passing channel is in communication with the plurality of flow-passing holes.

2. The centrifugal dispersion device of claim 1, wherein a second flow-passing channel configured for shearing of the slurry is defined between each of two opposite sidewalls of the blocking portion and a sidewall of the rotor outer cylinder facing the sidewall of the blocking portion, a third flow-passing channel configured for shearing of the slurry is defined between an inner wall of the blocking portion facing the shaft core and an outer wall of the rotor inner cylinder, the first flow-passing channel, the second flow-passing channel, and the third flow-passing channel are communicated in sequence, and the third flow-passing channel is in communication with two second flow-passing channels at both sides of the blocking portion.

3. The centrifugal dispersion device of claim 1, wherein in a radial direction of the shaft core, a distance between an inner wall of the blocking portion and the inner wall of the stator cylinder is larger than a distance between an inner wall of the rotor outer cylinder and the inner wall of the stator cylinder.

4. The centrifugal dispersion device of claim 2, wherein an extension direction of the first flow-passing channel and an extension direction of the third flow-passing channel are parallel to the axial direction of the shaft core, and an extension direction of the second flow-passing channel is perpendicular to the axial direction of the shaft core.

5. The centrifugal dispersion device of claim 4, wherein the first flow-passing channel has a width ranging from 2 mm to 3 mm.

6. The centrifugal dispersion device of claim 2, wherein the rotor cavity is a cavity structure with the rotor rib-plate as a cavity-bottom-wall, the outer wall of the rotor inner cylinder as a cavity-inner-peripheral-wall, an inner wall of the rotor outer cylinder as a cavity-outer-peripheral-wall, and one end of the rotor cavity facing away from the rotor rib-plate as an opening, and the rotor cavity is in direct communication with both the second flow-passing channel and the third flow-passing channel.

7. The centrifugal dispersion device of claim 6, wherein the rotor rib-plate is integrally formed at a middle of each of the rotor inner cylinder and the rotor outer cylinder, the rotor cavity is defined at each of two opposite sides of the rotor rib-plate, and the rotor outer cylinder corresponding to each of two rotor cavities defines flow-passing holes.

8. The centrifugal dispersion device of claim 7, wherein the flow-passing holes are implemented as a plurality of flow-passing holes, and the plurality of flow-passing holes are arranged at regular intervals in a circumferential direction of the rotor outer cylinder.

9. The centrifugal dispersion device of claim 1, wherein the cylinder body is provided with a front end-plate at one end of the cylinder body away from the driving member in the axial direction of the shaft core, the front end-plate is adapted to be connected to the screw extrusion device, and the front end-plate is configured to be sealed with and connected to an outer cylinder of the screw extrusion device through a fastener.

10. The centrifugal dispersion device of claim 1, wherein the cylinder body is provided with a rear end-plate at one end of the cylinder body close to the driving member in the axial direction of the shaft core, the driving member is sealed with and connected to the rear end-plate, the driving member is a motor, the motor is provided with a spindle that extends into an interior of the cylinder body and is connected to an output end of the motor, the shaft core is connected to the spindle at an outer periphery of the spindle, and the cylinder body is sealed with and connected to the spindle.

11. The centrifugal dispersion device of claim 1, wherein each of the plurality of rotor units has a dispersion speed ranging from 10 m/s to 30 m/s.

12. The centrifugal dispersion device of claim 1, wherein the plurality of flow-passing holes are arranged at irregular intervals in a circumferential direction of the rotor outer cylinder.

13. The centrifugal dispersion device of claim 1, wherein the blocking portion is configured to block the slurry in the rotor cavity, to make part of the slurry flow back to the first flow-passing channel to be sheared and dispersed.

14. The centrifugal dispersion device of claim 1, wherein a specification and a size of each of the plurality of rotor units and each of the plurality of stator units are changeable according to a property of the slurry that is fed, to change a width of the first flow-passing channel.

15. The centrifugal dispersion device of claim 1, wherein the rotor cavity is a smooth cavity without dead corners.

16. The centrifugal dispersion device of claim 1, wherein a shape of each of the plurality of flow-passing holes is round or oval or square.
